(19) United States
(12) Patent Application Publication
(10) Pub. No.: US 2006/0168582 A1
(43) Pub. Date: Jul. 27, 2006

(54) Managing resource link relationships to activity tasks in a collaborative computing environment

(75) Inventors: Michael Muller, Medford, MA (US); Charles Hill, Belmont, MA (US); Andrew L. Schimer, Andover, MA (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/040,393

(22) Filed: Jan. 21, 2005

(51) Int. Cl. G06F 9/46

(52) U.S. Cl. 718/100

(57) ABSTRACT

A method, system and apparatus for managing resource link relationships to activity tasks in a collaborative environment. In a preferred aspect of the present invention, a method for managing resource relationships to tasks in a collaborative environment can include creating relationship records for resources utilized in performing tasks in a task list, and storing the relationship records in association with respective ones of the tasks in the task list. The method further can include retrospectively accessing the relationship records to produce a historical view of the tasks in the task list.

### BACKGROUND OF THE INVENTION

1. Statement of the Technical Field

The present invention relates to the field of collaborative computing and more particularly to the management of resource link relationships with activity tasks in a collaborative computing environment.

2. Description of the Related Art

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among members of a workgroup. No longer merely restricted to document sharing, the modern collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, most goals and objectives can be achieved only through the participation of a multiplicity of individuals, each serving a specified role or roles in the process. Consequently, to provide computing tools designed for use only by one of the individuals in the process can be short sighted and can ignore important potential contributions lying among the other individuals involved in the process.

Personal information managers and project management systems represent two such individualized computing applications which attempt to manage a process leading to an objective despite the participation of many individuals in the process. Considering first the personal information manager (PIM), in a PIM, a single end user can establish a calendar of events and a to-do list of tasks which are to be performed by the end user. To the extent that a task is to be performed by another individual, the end user only can establish a task reminding the end user to monitor the completion of the task by the other individual. PIMs do permit the calendaring of events among different individuals, but the calendaring operation only can “invite” others to calendar the event within the personal information manager of other users.

Project management systems similarly are designed for the use of a single end user. In a traditional project management system, the phases of a project can be defined from start to finish and a timeline can be generated for the project. Utilizing the timeline, it can be determined when particular phases of the project have been completed and when a subsequently scheduled phase of the project can begin. To the extent that the timing of a phase of the project changes, the remaining project phases can be adjusted to accommodate the changed timing. Notably, in many project management systems, particular people can be assigned to particular phases of the project. In this way, the staffing of a project can be better managed by a project manager using the project management system.

Notwithstanding the foregoing, individualized PIMs and project management systems, as well as collaborative learning management systems, do not account for the actual nature of a coordinated set of tasks such as an activity. An activity, unlike a typical project or workflow, provides guidance, coordination and access to resources for people to carry out a grouped set of tasks in a project. Activities, unlike projects or workflows permit free variation in the completion of tasks. Thus, activities, unlike projects and workflows are not so rigid as to require a sequential completion of each phase of a project.

Notably, PIMs and project management systems do not manage the relationship between to-dos in a to-do list and the resources required or utilized in the completion of the to-dos in the to-do list. As a result, to-do items tend to be used only prospectively and not retrospectively. That is, to-do items are used only to cause the user to remember that an action should be taken in the future. Yet, to-do items are never used retrospectively so that records can be maintained regarding the past performance of a to-do. Moreover, knowledge cannot be obtained from conventional to-do lists in regard to the historical performance of the to-dos.

### SUMMARY OF THE INVENTION

The present invention addresses the deficiencies of the art in respect to to-do list management and provides a novel and non-obvious method, system and apparatus for managing resource link relationships to activity tasks in a collaborative environment. In a preferred aspect of the present invention, a method for managing resource relationships to tasks in a collaborative environment can include creating relationship records for resources utilized in performing tasks in a task list, and storing the relationship records in association with respective ones of the tasks in the task list. The method further can include retrospectively accessing the relationship records to produce a historical view of the tasks in the task list.

The creating step can include selecting a task in the task list on behalf of a collaborator, identifying an application for use in accessing a resource, accessing a resource on behalf of the collaborator, and generating a relationship record specifying the identified application, the collaborator and a timestamp. More specifically, the generating step can include generating a relationship record specifying the identified application, the collaborator; a timestamp; and a role fulfilled by the collaborator when accessing the resource. In either case, the method also can include the step of accessing another resource in temporal proximity to the step of accessing a resource on behalf of the collaborator, inferring a relationship between the step of accessing another resource and the step of accessing a resource on behalf of the collaborator, generating another relationship record for the another resource, and storing the another relationship record in association with the selected task.

The creating step can include selecting a task in the task list on behalf of a collaborator, identifying a multi-collaborator application for use in accessing a collaborative resource, accessing the collaborative resource on behalf of the collaborator, and generating a relationship record specifying the identified multi-collaborator application, the collaborator and a timestamp. Subsequently, the generated relationship record can be forwarded to other collaborators associated with the collaborative resource. Also, the accessing step can include selecting a task in the task list on behalf of a collaborator, identifying an application for use in accessing a resource previously utilized in performing the selected task, listing a selection of relationship records associated with the identified application and the selected task, selecting a particular one of the relationship records, and accessing a resource specified by the particular one of the relationship records.

In accordance with the present invention, a task list can include a listing of tasks and one or more relationship records linking selected ones of the tasks to resources utilized in completing the selected ones of the tasks. The task list further can include a user interface configured to present the selected tasks and linked relationship records. Each of the relationship records can include a specification of an application used to access a corresponding resource, an identity of a collaborator accessing the corresponding resource, and a timestamp of when the collaborator accessed the corresponding resource. For example, the relationship records can be doc-links. The user interface can include a “do-with” menu and a “retrieve-from” menu. Finally, the listing of tasks can include a listing of activity tasks in an activity view of an activity manager.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a unified activity manager which has been configured to manage resource link relationships to activity tasks in accordance with the present invention;

FIG. 2 is a block diagram illustrating an architecture for the unified activity manager of FIG. 1; and,

FIGS. 3A and 3B, taken together, are a pictorial illustration of the operation of a system, method and apparatus for managing resource link relationships to activity tasks.

### DETAILED DESCRIPTION OF THE PREFERRED EMBODIMENTS

The present invention is a method, system and apparatus for managing resource link relationships to activity tasks in a collaborative environment. In accordance with the present invention, link relationships can be recorded for resources utilized in the completion of an activity task. The link relationships can be explicitly specified, or inferred to be associated with a specific activity task. The link relationships, once recorded, can be viewed not only by the collaborator creating the link relationship, but also by other collaborators assigned to the activity task. Finally, the underlying resources for the link relationship can be retrieved in association with an activity task by a viewing collaborator. Importantly, the link relationships to the activity task can be utilized retrospectively in reviewing the historical progress of the activity task.

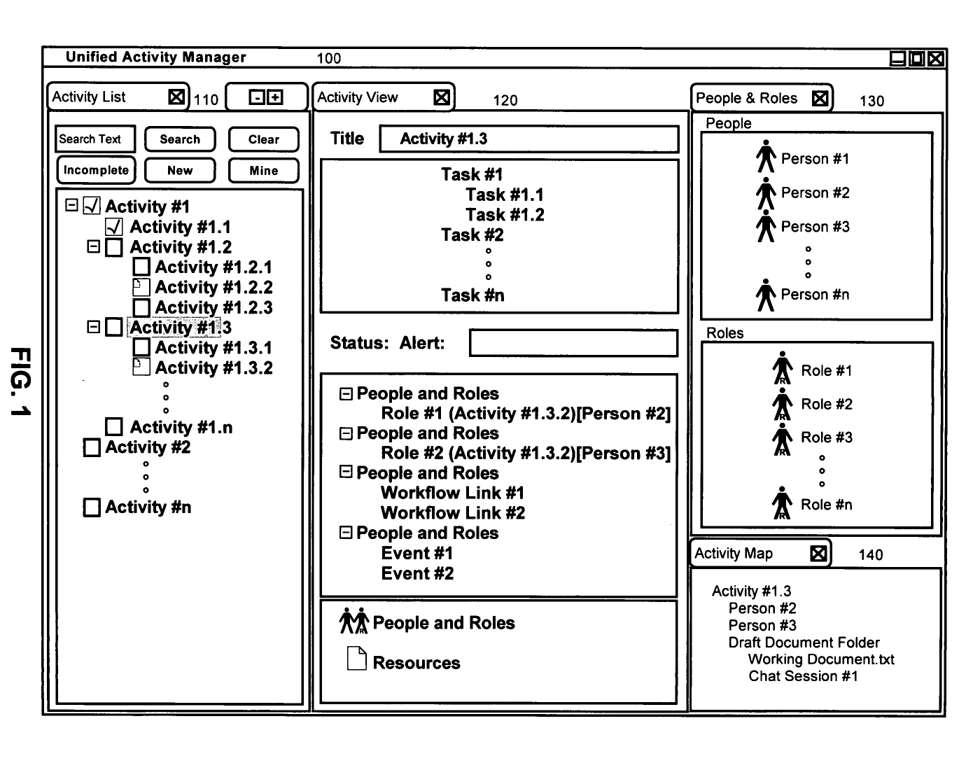

In an exemplary application, the resource link management system can be incorporated into a unified activity manager configured for the management of a hierarchy of activities, each activity optionally including one or more activity tasks. In further illustration, FIG. 1 is a pictorial illustration of a unified activity manager which has been configured in accordance with the present invention. The unified activity manager 100 can include several views including an activity checklist view 110, an activity view 120 and a people and roles view 130.

The activity checklist view 110 can include a listing of one or more activities. Each activity can be decomposed into zero or more dependent activities, which together comprise a richer description of the work summarized in the original activity. Each of these dependent activities is itself an activity, but appears in a subactivity-relationship to the original activity. This process of defining activities in subactivity-relationship may be extended to any desired level of dependent description.

The activity view 120 can include a description of one or more activity tasks contained within the activity. Additionally, the activity tasks can be decomposed into zero or more dependent activity tasks, which together comprise a richer procedural specification of the original activity task. Each of these dependent activity tasks itself can be an activity task, but appears in a subtask-relationship to the original activity task. This process of specifying activity tasks in subtask-relationship may be extended to any desired level of dependent specification.

The activity view 120 further can include a detailed listing of the properties of a selected activity in the activity checklist view 110. Specifically, the detailed listing can include a listing of collaborators (people) specified for the activity. Also, the detailed listing can include a listing of collaborator roles (roles) specified for the activity. Further, the detailed listing can include a listing of events specified for the activity. Finally, the detailed listing can include a listing of links to internal workflows, external workflows or both.

The peoples and roles view 130, in turn, can include a listing of collaborators in the collaborative environment available for assignment to a specified activity in the activity checklist view 110. The peoples and roles view 130 also can include a listing of collaborative roles in the collaborative environment available for assignment to a specified activity in the activity checklist view 110. In this regard, a role can be compared to a person in that a person references a specific identity and a role references only a class of persons.

Finally, an activity map 140 can be provided. The activity map 140 can include a hierarchically arranged set of electronic mail messages, calendar entries, documents, files and file folders, and applications, such as an application share, discussion thread or chat session, to name a few.

Importantly, in accordance with the present invention, a relationship between resources utilized in the completion of an activity task or sub-task in the activity view 120, and the activity task or sub-task can be recorded in association with the activity task or sub-task. In this regard, when a resource is utilized explicitly in concert with an activity task or sub-task, or implicitly as the case may be, a resource link can be created and associated with the activity task or sub-task. Subsequently, the relationship between the activity task or sub-task and all of the utilized resources can be viewed retrospectively. Moreover, collaborators accessing the activity task or sub-task further can view the relationship between the activity task or sub-task and all resources utilized by all collaborators in respect to the activity task or sub-task.

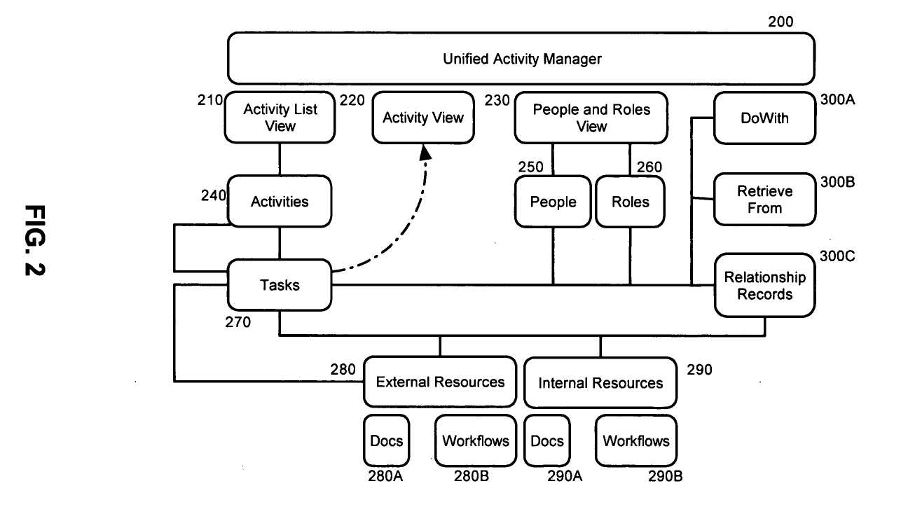

Turning now to FIG. 2, a block diagram is shown which illustrates the architecture for the unified activity manager of FIG. 1. The architecture can include the unified activity manager 200 which can have an activity checklist view 210, an activity view 220 and a people and roles view 230. The activity checklist view 210 can include one or more activities 240, each activity 240 having one or more tasks 270 or even other activities 240 defined through a sub-activity relationship. The activity view 220 can include a visual rendering of the properties of a selected one of the activities 270. Finally, the people and roles view 230 can include one or more people 250 and one or more roles 260. Importantly, references to the people 250 and roles 260 can be included in the tasks 270.

In accordance with the present invention, each of the activities 270 optionally can include links to both internal resources 280 and external resources 290. The internal resources 280 can include internally disposed documents 280A and internally specified workflows 280B to name only two. Similarly, the external resources 290 can include externally disposed documents 290A and externally specified workflows 290B. Other resources not shown can include references to internally available collaborative tools including application shares, chat sessions, document libraries, and e-mail messages, to name a few.

Utilizing the architecture of FIG. 2, activities can be created and managed so as to facilitate the collaborative achievement of a goal without requiring the use of a rigid, non-collaborative, conventional workflow or project management system. Rather, the activities can represent an informal and flexible structuring of to-dos and resources which can permit the collaborative execution of the activity in a conversational manner, regardless of the sequence of completion of the activity tasks and irrespective of whether all activity tasks in the activity are completed.

Importantly, the unified activity manager 200 yet further can include “do-with” logic 300A and “retrieve-from” logic 300B, each coupled to the activity tasks 270 and resources 280, 290. The do-with logic 300A can including programming which when executed can record one or more relationship records 300C, such as a doc-link, which can memorialize the relationship between the resources 280, 290 and the activity tasks 270. The retrieve-from logic 300B, by comparison, can produce already recorded relationship records 300C with which the underlying resources 280, 290 can be retrieved for viewing in relation to an associated one of the activity tasks 270. The retrieve-from logic 300B can use one or more search keys in the relationship records to retrieve the resources 280, 290, such as the name of an activity task associated with each of the resource 280, 290, the application used to create or access the resources 280, 290, or the date of access, to name only three such keys.

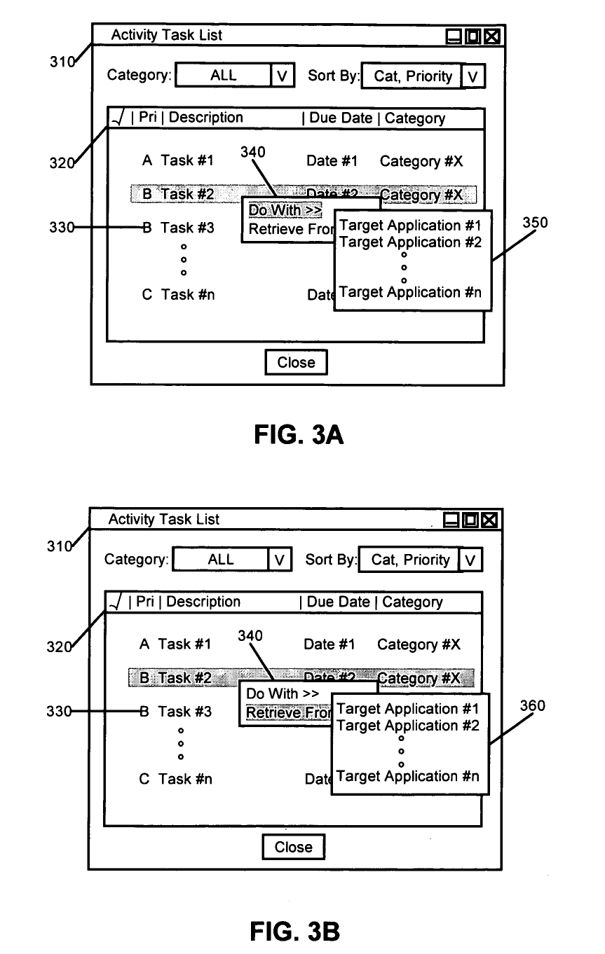

In further illustration of the principle of operation of do-with and retrieve-from logic 300A, 300B, FIGS. 3A and 3B, taken together, are a pictorial illustration of the operation of a system, method and apparatus for managing resource link relationships to activity tasks which subsists irrespective of the presence of the unified activity manager. As shown in FIGS. 3A and 3B, an activity task list manager 310 is shown which can include a task list 320 having included therein one or more tasks 330. Any one of the tasks 330 can be selected and a context menu 340 can be generated which can provide both a “do-with” selection and a “retrieve-from” selection.

Referring specifically to FIG. 3A, the activation of the do-with selection in the context menu 340 can produce a do-with menu 350. The do-with menu 350 can provide a listing of collaborative tools for creating and maintaining resources. The resources in of themselves can be used in furtherance of the completion of the selected one of the tasks 330. For instance, the resources can include documents, messages, transcripts of real-time communications sessions such as an instant messaging or chat session, a database, and the like. Once a collaborative tool has been selected from the do-with menu 350, a resource can be created utilizing the collaborative tool and a relationship can be stored as between the created resource and the selected one of the tasks 330. In this way, at any time the resource can be located through a query of the selected one of the tasks 330.

More particularly, referring to FIG. 3B, the activation of the retrieve-from selection in the context menu 340 can produce a retrieve-from menu 360. The retrieve-from menu 360 can provide a listing of collaborative tools for creating and maintaining resources. Once a collaborative tool has been selected from the retrieve-from menu 360, a set of resources created utilizing the collaborative tool and associated with the selected one of the tasks 330 can be retrieved for viewing. In this regard, the set of resources can be determined by way of the recorded relationships stored as between the created resource and the selected one of the tasks 330.

As an example, in a preferred aspect of the invention, when a document is created and stored into a shared document library through a do-with menu, a relationship record, for instance a doc-link, can be created which associates the created document with the selected task. Of course, a relationship can be maintained as between the document and the collaborative tool utilized to create the document. The relationship record itself can record a link to the resource, the identity of the collaborator giving rise to the relationship record, a timestamp indicating when the relationship record had been created and, optionally, the role of the collaborator at the time of the creation of the relationship record. To the extent that the task is a recurring task, a search across the name of the task can produce all documents produced in the performance of the recurring task.

As another example, in another preferred aspect of the invention, a relationship record can be created as between a task and a resource, even if an existing resource is merely selected for viewing by one addressing the task. Moreover, when a response document is created for the existing resource, another relationship record can be created for the response document, even if the do-with menu is not used to create the response document. In that the response document had been created in temporal proximity to the review of the existing resource, it can be presumed that the two resources are related and the automatic nature of the relationship record can be noted. To defeat the automatic creation of a relationship record for presumptively related resources, a collaborator can explicitly choose to end a do-with operation.

As yet another example, in yet another preferred aspect of the invention, a relationship record can be created as between a task and a multi-collaborator resource such as a chat transcript. Moreover, in as much as the other collaborators to the chat transcript may not be associated with the underlying task, the relationship record can be provided to the other collaborators, such as by way of an e-mail message. Consequently, the other collaborators can choose whether or not to save the relationship record their respective task lists.

Finally, it is important to note that the relation records can be stored in association with tasks in a task list, as well as activity tasks in an activity view. As a result, the relationship records can be manipulated directly from the task list. For instance, when a composed message is to incorporate a link to a resource, the link can be retrieved directly from the task list through an associated relationship record and the resource need not be located through a resource location interface.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for managing resource relationships to tasks in a collaborative environment, the method comprising the steps of:
creating relationship records for resources utilized in performing tasks in a task list; and,
storing said relationship records in association with respective ones of said tasks in said task list.

2. The method of claim 1, further comprising the step of retrospectively accessing said relationship records to produce a historical view of said tasks in said task list.

3. The method of claim 1, wherein said creating step comprises the steps of:
selecting a task in said task list on behalf of a collaborator;
identifying an application for use in accessing a resource;
accessing a resource on behalf of said collaborator; and,
generating a relationship record specifying said identified application, said collaborator and a timestamp.

4. The method of claim 3, wherein said generating step comprises the step of generating a relationship record specifying said identified application, said collaborator; a timestamp; and a role fulfilled by said collaborator when accessing said resource.

5. The method of claim 3, further comprising the steps of:
accessing another resource in temporal proximity to said step of accessing a resource on behalf of said collaborator;
inferring a relationship between said step of accessing another resource and said step of accessing a resource on behalf of said collaborator;
generating another relationship record for said another resource; and,
storing said another relationship record in association with said selected task.

6. The method of claim 1, wherein said creating step comprises the step of:
selecting a task in said task list on behalf of a collaborator;
identifying a multi-collaborator application for use in accessing a collaborative resource;
accessing said collaborative resource on behalf of said collaborator;
generating a relationship record specifying said identified multi-collaborator application, said collaborator and a timestamp; and,
forwarding said relationship record to other collaborators associated with said collaborative resource.

7. The method of claim 2, wherein said accessing step comprises the steps of:
selecting a task in said task list on behalf of a collaborator;
listing a selection of relationship records associated with said selected task;
selecting a particular one of said relationship records; and,
accessing a resource specified by said particular one of said relationship records.

8. The method of claim 2, wherein said accessing step comprises the steps of:
selecting a task in said task list on behalf of a collaborator;
identifying an application for use in accessing a resource previously utilized in performing said selected task;
listing a selection of relationship records associated with said identified application and said selected task.
selecting a particular one of said relationship records; and,
accessing a resource specified by said particular one of said relationship records.

9. The method of claim 2 wherein said accessing step comprises the steps of:
selecting a task in said task list on behalf of a collaborator;
identifying a date range in which a resource was previously utilized in performing said selected task;
listing a selection of relationship records associated with said identified date range and said selected task;
selecting a particular one of said relationship records; and,
accessing a resource specified by said particular one of said relationship records.

10. A task list comprising:
a listing of tasks;
a plurality of relationship records linking selected ones of said tasks to resources utilized in completing said selected ones of said tasks; and,
a user interface configured to present said selected tasks and linked relationship records.

9. The task list of claim 8, wherein each of said relationship records comprises a specification of an application used to access a corresponding resource, an identity of a collaborator accessing said corresponding resource, and a timestamp of when said collaborator accessed said corresponding resource.

10. The task list of claim 8, wherein said relationship records are doc-links.

11. The task list of claim 8, wherein said user interface comprises a do-with menu.

12. The task list of claim 11, wherein said user interface further comprises a retrieve-from menu.

13. The task list of claim 8, wherein said listing of tasks comprises a listing of activity tasks in an activity view of an activity manager.

14. A machine readable storage having stored thereon a computer program for managing resource relationships to tasks in a collaborative environment, the computer program comprising a routine set of instructions which when executed by a machine, causes the machine to perform the steps of:
creating relationship records for resources utilized in performing tasks in a task list; and,
storing said relationship records in association with respective ones of said tasks in said task list.

15. The machine readable storage of claim 14, further comprising an additional set of instructions which when executed by the machine causes the machine to further perform the step of retrospectively accessing said relationship records to produce a historical view of said tasks in said task list.

16. The machine readable storage of claim 14, wherein said creating step comprises the steps of:
selecting a task in said task list on behalf of a collaborator;
identifying an application for use in accessing a resource;
accessing a resource on behalf of said collaborator; and,
generating a relationship record specifying said identified application, said collaborator and a timestamp.

17. The machine readable storage of claim 16, wherein said generating step comprises the step of generating a relationship record specifying said identified application, said collaborator; a timestamp; and a role fulfilled by said collaborator when accessing said resource.

18. The machine readable storage of claim 16, further comprising an additional set of instructions which when executed by the machine causes the machine to further perform the steps of:
accessing another resource in temporal proximity to said step of accessing a resource on behalf of said collaborator;
inferring a relationship between said step of accessing another resource and said step of accessing a resource on behalf of said collaborator;
generating another relationship record for said another resource; and,
storing said another relationship record in association with said selected task.

19. The machine readable storage of claim 14, wherein said creating step comprises the step of:
selecting a task in said task list on behalf of a collaborator;
identifying a multi-collaborator application for use in accessing a collaborative resource;
accessing said collaborative resource on behalf of said collaborator;
generating a relationship record specifying said identified multi-collaborator application, said collaborator and a timestamp; and,
forwarding said relationship record to other collaborators associated with said collaborative resource.

20. The machine readable storage of claim 15, wherein said accessing step comprises the steps of:
selecting a task in said task list on behalf of a collaborator;
listing a selection of relationship records associated with said selected task;
selecting a particular one of said relationship records; and,
accessing a resource specified by said particular one of said relationship records;

21. The machine readable storage of claim 15, wherein said accessing step comprises the steps of:
selecting a task in said task list on behalf of a collaborator;
identifying an application for use in accessing a resource previously utilized in performing said selected task;
listing a selection of relationship records associated with said identified application and said selected task.
selecting a particular one of said relationship records; and,
accessing a resource specified by said particular one of said relationship records.

22. The machine readable storage of claim 15, wherein said accessing step comprises the steps of:
selecting a task in said task list on behalf of a collaborator;
identifying a date range in which a resource was previously utilized in performing said selected task;
listing a selection of relationship records associated with said identified date range and said selected task;
selecting a particular one of said relationship records; and,
accessing a resource specified by said particular one of said relationship records.
